(19) United States
(12) Patent Application Publication
(10) Pub. No.: US 2024/0205983 A1
(43) Pub. Date: Jun. 20, 2024

(54) METHOD AND DEVICE FOR TRANSMITTING AND RECEIVING FRAME IN CONSIDERATION OF LENGTH OF DATA IN COMMUNICATION SYSTEM SUPPORTING MULTIPLE LINKS

(71) Applicants: HYUNDAI MOTOR COMPANY, Seoul (KR); KIA CORPORATION, Seoul (KR); Korea National University of Transportation Industry-Academic Cooperation Foundation, Chungju-si (KR)

(72) Inventor: Yong Ho Kim, Incheon (KR)

(73) Assignees: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(21) Appl. No.: 18/543,886

(22) Filed: Dec. 18, 2023

Related U.S. Application Data
(63) Continuation-in-part of application No. PCT/KR2022/008176, filed on Jun. 10, 2022.

(30) Foreign Application Priority Data
Jun. 18, 2021 (KR) 10-2021-0079468
Jun. 9, 2022 (KR) 10-2022-0070272

(51) Int. Cl. H04W 74/0833; H04W 76/20; H04W 84/12

(52) U.S. Cl. CPC H04W 74/085; H04W 76/20; H04W 84/12

(57) ABSTRACT

In a method and device for transmitting and receiving a frame in consideration of the length of data in a communication system supporting multiple links, the method of a first device includes the steps of: receiving a first frame from a second device in a first TXOP on a first link; receiving a second frame from the second device in a second TXOP on a second link; performing a first backoff operation for transmitting a first reception response frame for the first frame on the first link; and “when the first backoff operation is completed and the reception of the second frame is completed”, transmitting the first reception response frame to the second device on the first link.

### CROSS-REFERENCE TO RELATED APPLICATION

The present application is a continuation-in-part of currently pending International Patent Application No. PCT/KR2022/008176, filed Jun. 10, 2022, which claims priority to Korean Patent Application Number 10-2021-0079468, filed Jun. 18, 2021 and Korean Patent Application Number 10-2022-0070272, filed Jun. 9, 2022, the entire contents of which are incorporated herein for all purposes by these references.

### BACKGROUND OF THE PRESENT DISCLOSURE

### Field of the Present Disclosure

The present disclosure relates to a wireless local area network (LAN) communication technique, and more particularly, to a technique for transmitting and receiving a response frame in a device that does not support simultaneous transmit and receive (STR) operations.

### DESCRIPTION OF RELATED ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since multi-link operations are operations not defined in the existing wireless LAN standard, it may be necessary to define detailed operations according to an environment in which the multi-link operations are performed. In particular, when two or more links are adjacent, simultaneous transmit and receive (STR) operations may not be performed on a multi-link due to interference from adjacent links (e.g., adjacent bands, adjacent channels). If a level of signal interference between adjacent links is above a certain level, a channel sensing operation and/or signal reception operation for transmission on another link may not be performed due to the interference while a transmission operation is performed on one link. In the above-described situation, methods for transmitting and receiving data based on a channel access procedure considering a transmission and reception status of the one link may be required.

The information included in this Background of the present disclosure is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a method and an apparatus for transmitting and receiving a frame considering a length of data in a device that does not support STR operations in a communication system supporting a multi-link.

A method of a first device, according to various exemplary embodiments of the present disclosure for achieving the above-described objective, may include: receiving a first frame from a second device in a first transmit opportunity (TXOP) of a first link; receiving a second frame from the second device in a second TXOP of a second link; performing a first backoff operation for transmission of a first reception response frame for the first frame on the first link; and in response that the first backoff operation is completed and reception of the second frame is completed, transmitting the first reception response frame to the second device on the first link, wherein the first TXOP is shorter than the second TXOP, and a reception completion time of the second frame is after a reception completion time of the first frame.

An acknowledgement (ACK) policy field included in a medium access control (MAC) header of the first frame may be set to a value indicating non-simultaneous transmit and receive (NSTR) multi-link (ML) ACK, and the ACK policy field set to the value indicating the NSTR ML ACK may indicate to transmit the first reception response frame after completion of reception of the second frame.

The first frame may include a block ACK request (BAR) indicating NSTR ML ACK, and the BAR may indicate to transmit the first reception response frame after completion of reception of the second frame.

The first backoff operation may be repeatedly performed until reception of the second frame is completed; when the first backoff operation is completed before reception of the second frame is completed, a backoff counter value for the first backoff operation may be maintained at 0 until reception of the second frame is completed; or the first backoff operation may be performed after reception of the second frame is completed.

When the first device is an access point (AP) multi-link device (MLD), the second device may be a station (STA) MLD, and when the first device is an STA MLD, the second device may be an AP MLD; the AP MLD may support a simultaneous transmit and receive (STR) operation on the first link and the second link; and the STA MLD may not support the STR operation on the first link and the second link.

A station (STA) 1 affiliated with the STA MLD may perform a low-power operation on the first link in a period from an end time of the first frame to an end time of the second frame.

A method of a first device, according to various exemplary embodiments of the present disclosure for achieving the above-described objective, may include: receiving a first frame from a second device in a first transmit opportunity (TXOP) of a first link; receiving a second frame from the second device in a second TXOP of a second link; and in response that information included in the first frame indicates that a first reception response for the first link is transmitted on the second link, transmitting the first reception response for the first frame and a second reception response for the second frame to the second device on the second link, wherein the first TXOP is shorter than the second TXOP, and a reception completion time of the second frame is after a reception completion time of the first frame.

The information may be an acknowledgement (ACK) policy field included in a medium access control (MAC) header of the first frame, and the ACK policy field may be set to a value indicating non-simultaneous transmit and receive (NSTR) multi-link (ML) ACK.

The information may be a block ACK request (BAR) included in the first frame.

The transmitting to the second device may include: generating one reception response frame including the first reception response and the second reception response; and transmitting the one reception response frame to the second device.

The transmitting to the second device may include: transmitting a first reception response frame including the first reception response to the second device; and transmitting a second reception response frame including the second reception response to the second device.

When the first device is an access point (AP) multi-link device (MLD), the second device may be a station (STA) MLD, and when the first device is an STA MLD, the second device may be an AP MLD; the AP MLD may support a simultaneous transmit and receive (STR) operation on the first link and the second link; and the STA MLD may not support the STR operation on the first link and the second link.

A method of a first device, according to various exemplary embodiments of the present disclosure for achieving the above-described objective, may include: receiving a first frame from a second device in a first transmit opportunity (TXOP) of a first link; receiving a second frame from the second device in a second TXOP of a second link; and in response that information included in the first frame requests to transmit a first reception response frame for the first frame on a third link that does not have a non-simultaneous transmit and receive (NSTR) link pair relationship with the first link, transmitting the first reception response frame to the second device on the third link.

The first link and the second link may be a non-simultaneous transmit and receive (NSTR) link pair, the first TXOP may be shorter than the second TXOP, and a reception completion time of the second frame may be after a reception completion time of the first frame.

The transmitting to the second device may comprise: selecting the third link not having an NSTR link pair relationship with the first link from among links mapped to an access category (AC) of the first frame; performing a first backoff operation for transmission of the first reception response frame on the third link; and when the first backoff operation is completed, transmitting the first reception response frame to the second device on the third link.

The third link may be selected based on traffic identifier (TID)-to-link mapping.

The first backoff operation on the third link may be performed using an enhanced distributed channel access (EDCA) parameter for an AC of the first frame.

The information may be an acknowledgment (ACK) policy field included in a medium access control (MAC) header of the first frame, and the ACK policy field may be set to a value indicating NSTR multi-link (ML) ACK.

When the first device is an access point (AP) multi-link device (MLD), the second device may be a station (STA) MLD, and when the first device is an STA MLD, the second device may be an AP MLD; the AP MLD may support a simultaneous transmit and receive (STR) operation on the first link and the second link; and the STA MLD may not support the STR operation on the first link and the second link.

According to an exemplary embodiment of the present disclosure, communication between devices (e.g., station, access point) may be performed using multiple links. If some links (e.g., some channels) among the multiple links are adjacent, STR operations may not be performed. If the length of a data unit to be transmitted on the first link is different from the length of a data unit to be transmitted on the second link, the device may set the lengths of the data units to be transmitted on the first link and the second link to be the same, and then perform a simultaneous transmission operation on the first link and the second link. Accordingly, the transmission efficiency in the communication system can be improved.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating various exemplary embodiments of a communication node constituting a wireless LAN system.

FIG. 2 is a conceptual diagram illustrating various exemplary embodiments of a multi-link configured between multi-link devices (MLDs).

FIG. 3 is a timing diagram illustrating various exemplary embodiments of a method for transmitting and receiving frames when different TXOP limits are applied in a wireless LAN system supporting multiple links.

FIG. 4 is a timing diagram illustrating various exemplary embodiments of a method for transmitting and receiving frames when different TXOP limits are applied in a wireless LAN system supporting multiple links.

FIG. 5 is a timing diagram illustrating various exemplary embodiments of a method for transmitting and receiving frames when different TXOP limits are applied in a wireless LAN system supporting multiple links.

FIG. 6 is a timing diagram illustrating various exemplary embodiments of a method for transmitting and receiving frames when different TXOP limits are applied in a wireless LAN system supporting multiple links.

FIG. 7 is a timing diagram illustrating various exemplary embodiments of a method for transmitting and receiving frames when different TXOP limits are applied in a wireless LAN system supporting multiple links.

FIG. 8 is a timing diagram illustrating various exemplary embodiments of a method for transmitting and receiving frames when different TXOP limits are applied in a wireless LAN system supporting multiple links.

FIG. 9A is a timing diagram illustrating various exemplary embodiments of a multi-user (MU) transmission method in a wireless LAN system supporting a multi-link.

FIG. 9B is a timing diagram illustrating various exemplary embodiments of an MU transmission method in a wireless LAN system supporting a multi-link.

FIG. 10 is a timing diagram illustrating various exemplary embodiments of an MU transmission method in a wireless LAN system supporting a multi-link.

FIG. 11 is a timing diagram illustrating various exemplary embodiments of an MU transmission method in a wireless LAN system supporting a multi-link.

FIG. 12 is a timing diagram illustrating various exemplary embodiments of an MU transmission method in a wireless LAN system supporting a multi-link.

FIG. 13 is a timing diagram illustrating various exemplary embodiments of an MU transmission method in a wireless LAN system supporting a multi-link.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments of the present disclosure, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the present disclosure, to facilitate the entire understanding of the present disclosure, like numbers refer to like elements throughout the description of the figures and the repetitive description thereof will be omitted.

In the following, a wireless communication system to which exemplary embodiments according to an exemplary embodiment of the present disclosure are applied will be described. The wireless communication system to which the exemplary embodiments according to an exemplary embodiment of the present disclosure are applied is not limited to the contents described below, and the exemplary embodiments according to an exemplary embodiment of the present disclosure can be applied to various wireless communication systems. A wireless communication system may be referred to as a ‘wireless communication network’.

In exemplary embodiments of the present disclosure, ‘configuration of an operation (e.g., transmission operation)’ may mean that ‘configuration information (e.g., information element(s), parameter(s)) for the operation’ and/or ‘information indicating to perform the operation’ is signaled. ‘Configuration of an information element (e.g., parameter)’ may mean that the information element is signaled. ‘Configuration of a resource (e.g., resource region)’ may mean that setting information of the resource is signaled.

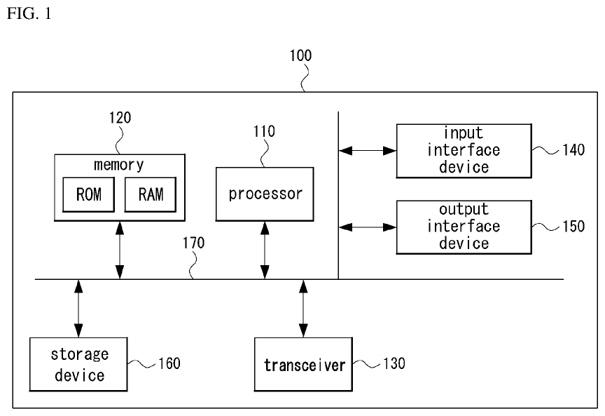

FIG. 1 is a block diagram illustrating a first exemplary embodiment of a communication node constituting a wireless LAN system.

As shown in FIG. 1, a communication node 100 may be an access point, a station, an access point (AP) multi-link device (MLD), or a non-AP MLD. An access point may refer to ‘AP’, and a station may refer to ‘STA’ or ‘non-AP STA’. An operating channel width supported by an AP may be 20 megahertz (MHz), 80 MHz, 160 MHz, or the like. An operating channel width supported by a STA may be 20 MHz, 80 MHz, or the like.

The communication node 100 may include at least one processor 110, a memory 120, and a transceiver 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The respective components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, and the storage device 160 through a dedicated interface.

The processor 110 may execute program commands stored in at least one of the memory 120 and the storage device 160. The processor 110 may refer to a central processing unit (CPU), a graphics processing unit (GPU), or a dedicated processor on which the methods according to the exemplary embodiments of the present invention are performed. Each of the memory 120 and the storage device 160 may be configured as at least one of a volatile storage medium and a nonvolatile storage medium. For example, the memory 120 may be configured with at least one of a read only memory (ROM) and a random access memory (RAM).

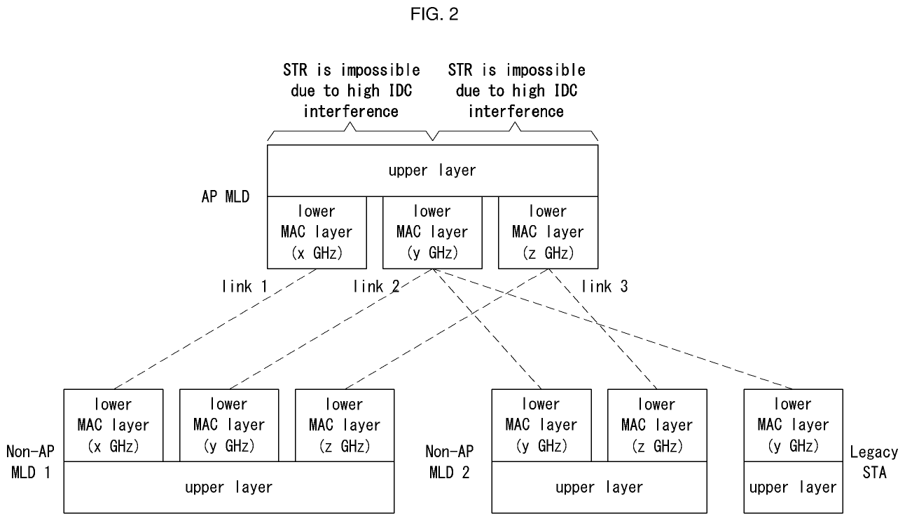

FIG. 2 is a conceptual diagram illustrating a first exemplary embodiment of a multi-link configured between multi-link devices (MLDs).

As shown in FIG. 2, an MLD may have one medium access control (MAC) address. In exemplary embodiments of the present disclosure, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In the instant case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments of the present disclosure, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by use of a non-contiguous bandwidth extension scheme (e.g., 80 MHz+80 MHZ). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In the instant case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur. Accordingly, when the bandwidth separation between multiple links is not sufficient, the MLD may not be able to perform an STR operation. A link pair having the above-described interference relationship may be a non-simultaneous transmit and receive (NSTR)-limited link pair. Here, the MLD may be referred to as ‘NSTR AP MLD’ or ‘NSTR non-AP MLD’.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

Meanwhile, in a wireless LAN system, a negotiation procedure for a multi-link operation may be performed in an access procedure between a station and an access point.

A device (e.g., access point, station) that supports multiple links may be referred to as ‘multi-link device (MLD)’. An access point supporting multiple links may be referred to as ‘AP MLD’, and a station supporting multiple links may be referred to as ‘non-AP MLD’ or ‘STA MLD’. The AP MLD may have a physical address (e.g., MAC address) for each link. The AP MLD may be implemented as if an AP in charge of each link exists separately. A plurality of APs may be managed within one AP MLD. Therefore, coordination between a plurality of APs belonging to the same AP MLD may be possible. A STA MLD may have a physical address (e.g., MAC address) for each link. The STA MLD may be implemented as if a STA in charge of each link exists separately. A plurality of STAs may be managed within one STA MLD. Therefore, coordination between a plurality of STAs belonging to the same STA MLD may be possible.

For example, an AP1 of the AP MLD and a STA1 of the STA MLD may each be responsible for a first link and perform communication using the first link. An AP2 of the AP MLD and a STA2 of the STA MLD may each be responsible for a second link and perform communication using the second link. The STA2 may receive status change information for the first link on the second link. In the instant case, the STA MLD may collect information (e.g., status change information) received on the respective links, and control operations performed by the STA1 based on the collected information.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP. In exemplary embodiments of the present disclosure, an operation of a STA may be interpreted as an operation of a STA MLD, an operation of a STA MLD may be interpreted as an operation of a STA, an operation of an AP may be interpreted as an operation of an AP MLD, and an operation of an AP MLD may be interpreted as an operation of an AP.

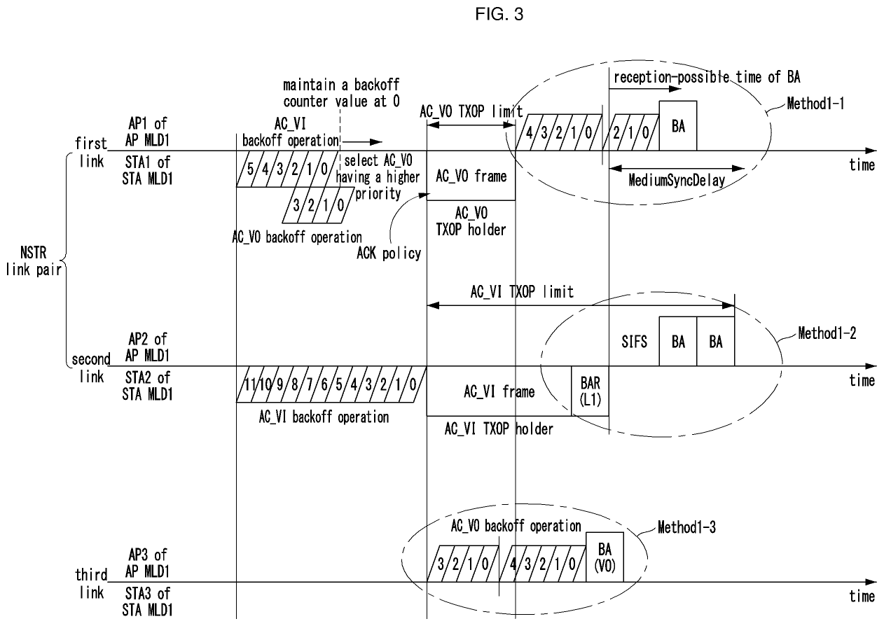

FIG. 3 is a timing diagram illustrating a first exemplary embodiment of a method for transmitting and receiving frames when different TXOP limits are applied in a wireless LAN system supporting multiple links.

As shown in FIG. 3, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. The STA MLD1 may operate as an NSTR STA MLD on a specific link pair (e.g., a pair of a first link and a second link), and may operate as an STR STA MLD on another link pair (e.g., a pair of the first link and a third link, and/or a pair of the second link and the third link). That is, the STA MLD1 cannot perform STR operations on the pair of the first link and the second link, and can perform STR operations on the pair of the first link and the third link and/or the pair of the second link and the third link.

The AP MLD1 may transmit and receive data frames with the STA MLD1 using multiple links. The AP1 of AP MLD1 and the STA1 of STA MLD1 may operate on the first link, the AP2 of AP MLD1 and the STA2 of STA MLD1 may operate on the second link, and the AP3 of AP MLD1 and the STA3 of STA MLD1 may operate on the third link. Each of the AP1 and STA1 may perform a backoff operation for frame transmission on the first link, each of the AP2 and STA2 may perform a backoff operation for frame transmission on the second link, and each of the AP3 and STA3 may perform a backoff operation for frame transmission on the second link.

The backoff operation may be performed independently on each link. The backoff operation may be an Enhanced Distributed Channel Access Function (EDCAF). The backoff operations on the links may be backoff operations for the same Access Category (AC). Alternatively, the backoff operations on the links may be backoff operations for different ACs. Multiple backoff operations (e.g., multiple backoff operations for multiple ACs) may be performed on one link. Value(s) of EDCA parameter(s) for the backoff operation may be different for each AC. Priorities of ACs may be defined as in Table 1 below, and contention windows (CWs) for the ACs may be defined as in Table 2 below.

TABLE 1

| Priority | AC | Description |
|---|---|---|
| Lowest | AC_BK | Background |
| | AC_BE | Best effort |
| Highest | AC_VI | Video |
| | AC_VO | Voice |

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The backoff operations for synchronous transmission may be performed for the same AC on both the first and second links and may use the same EDCA parameter(s). Counter values for the backoff operations on the first link and the second link may be selected independently. The counter value may mean a backoff counter value. A backoff operation on one (e.g., first link) of the first link and the second link may succeed first when the corresponding backoff counter value becomes 0. For example, a backoff operation may succeed first on a link (e.g., first link) for which a smaller backoff counter value is selected. The backoff counter value on the first link where the backoff operation succeeds may be maintained at 0 until the backoff operation succeeds on another link (e.g., second link). In the instant case, transmission on the first link may be delayed (i.e., queued).

The STA1 of STA MLD1 may simultaneously perform a backoff operation for AC_VI (hereinafter referred to as ‘AC_VI backoff operation’) and a backoff operation for AC_VO (hereinafter referred to as ‘AC_VO backoff operation’) on the first link. The AC_VI backoff operation may succeed before the AC_VO backoff operation, and an AC_VI backoff counter value on the first link may be maintained at 0 until a backoff counter value on the second link becomes 0. The AC_VO backoff operation may be completed while waiting for transmission of AC_VI data on the first link. In the instant case, both the AC_VI backoff counter value and the AC_VO backoff counter value on the first link may be 0.

When backoff operations for two or more ACs succeed on one link, an internal collision resolution procedure may be performed to select one AC as a transmission target. In the internal collision resolution procedure, an AC with a higher priority among the two or more ACs may be selected. Since the priority of AC_VO is higher than the priority of AC_VI, AC_VO may be selected in the internal collision resolution procedure. That is, it may be determined that the AC_VO backoff operation on the first link is successful. When an AC_VI backoff operation succeeds on the second link (e.g., when an AC_VI backoff counter value is 0), the STA1 of STA MLD1 may transmit an AC_VO frame on the first link, and the STA2 of STA MLD1 may transmit an AC_VI frame on the second link. The AC_VO frame on the first link and the AC_VI frame on the second link may be transmitted simultaneously. The AC_VO frame may refer to a data frame including a data unit for AC_VO (e.g., an AC_VO physical layer protocol data unit (PPDU) or AC_VO medium access control (MAC) protocol data unit (MPDU)), and the AC_VI frame may refer to a data frame including a data unit for AC_VI (e.g., AC_VI PPDU or AC_VI MPDU).

A duration of a transmit opportunity (TXOP) may be a time that allows a communication node securing the TXOP (e.g., TXOP holder) to use a medium without interference. The communication node may be an AP, STA, AP MLD, and/or STA MLD. The duration of the TXOP may include a time required for transmission of a reception response frame, which is an immediate response transmitted to the TXOP holder. The reception response frame may be an acknowledgment (ACK) frame or a block ACK (BA) frame. The maximum duration of the TXOP (hereinafter referred to as ‘TXOP limit’) may be set for each AC. The AP may configure an EDCA parameter set element including information of the TXOP limit, and may transmit a management frame (e.g., beacon frame, probe response frame, and/or association response frame) including the corresponding EDCA parameter set element to STA(s). A default TXOP limit for each AC may be set as shown in Table 3 below. The default TXOP limit for each AC may be set to a value different from Table 3.

TABLE 3

| AC | Default TXOP limit |
|---|---|
| AC_BK | 2.528 ms |
| AC_BE | 2.528 ms |
| AC_VI | 4.069 ms |
| AC_VO | 2.080 ms |

The STA1 may obtain a TXOP for AC_VO frame transmission on the first link, and the STA2 may obtain a TXOP for AC_VI frame transmission on the second link. That is, the STA1 may be a TXOP holder on the first link, and the STA2 may be a TXOP holder on the second link. The TXOP obtained by the STA1 on the first link may be configured based on the TXOP limit for AC_VO frame. The TXOP obtained by the STA2 on the second link may be configured based the TXOP limit for AC_VI frame. Simultaneous transmission operations may be initiated on the first link and the second link. The TXOP limit for AC_VO frame on the first link (hereinafter referred to as ‘AC_VO TXOP limit’) may be shorter than the TXOP limit for AC_VI frame on the second link (hereinafter referred to as ‘AC_VI TXOP limit’). Accordingly, the STA MLD1 may not be able to set an end time of the AC_VO frame transmitted on the first link to be the same as an end time of the AC_VI frame transmitted on the second link. That is, when padding is added to the AC_VO frame on the first link, the AC_VO frame including the padding may exceed the AC_VO TXOP limit, so a padding procedure for matching a transmission end time of the AC_VI frame on the first link to a transmission end time of the AC_VO frame on the second link cannot be performed.

The simultaneous transmission of the AC_VO frame on the first link and the AC_VI frame on the second link may be performed. The STA1 may transmit the AC_VO frame on the first link by adjusting the length of the AC_VO frame (e.g., AC_VO PPDU, AC_VO MPDU) in consideration of reception of a reception response frame (e.g., BA frame or ACK frame). Alternatively, since the STA2 is transmitting the AC_VI frame (e.g., AC_VI PPDU, AC_VI MPDU) on the second link and the TXOP of the STA2 (e.g., TXOP configured based on the AC_VI TXOP limit) is longer than the TXOP and the STA1, the STA1 may not be able to receive the reception response frame due to an NSTR problem. Therefore, the STA1 may transmit the AC_VO frame using the entire period of the obtained TXOP. The STA1 may separately receive the reception response frame using methods to be described later. Since the STA2 of STA MLD1 transmits the AC_VI frame within the AC_VI TXOP limit of the second link, the STA1 may not be able to receive the reception response frame (e.g., ACK frame or BA frame) for the AC_VO frame on the first link having an NSTR link pair relationship with the second link during a time corresponding to the AC_VI TXOP limit of the second link. That is, the STA1 may not be able to immediately receive the reception response frame for the AC_VO frame transmitted within the AC_VO TXOP limit of the first link. In the instant case, the reception response frame may be received based on at least one method among three methods. Since the reception response frame for the AC_VO frame cannot be received immediately, the STA1 of STA MLD1 may set an ACK policy field included in a MAC header of the AC_VO frame to a value indicating NSTR multi-link (ML) ACK, and transmit the corresponding AC_VO frame. The AP1 may receive the AC_VO frame from the STA1 and identify that the ACK policy field included in the MAC header of the AC_VO frame indicates the NSTR ML ACK. In the instant case, the AP1 may transmit the reception response frame for the AC_VO frame using at least one method among three methods. In exemplary embodiments of the present disclosure, an NSTR link pair may mean a pair of links on which STR operations of the STA MLD (e.g., STA MLD1) cannot be performed. An STR link pair may mean a pair of links on which STR operations of the STA MLD can be performed.

### Method 1-1 of Transmitting and Receiving a Reception Response Frame

The AP MLD1 may perform a backoff operation for transmission of the reception response frame for the AC_VO frame on the first link on which the data frame (e.g., AC_VO frame) is received. When a backoff counter value for transmission of the reception response frame is 0, the AP1 of AP MLD1 may transmit the reception response frame for the AC_VO frame to the STA1 after a time when the STA1 of STA MLD1 can receive the reception response frame (e.g., after transmission of the data frame (e.g., AC_VI frame) on the second link is completed). A period from an end time (e.g., transmission completion point) of the AC_VO frame on the first link to an end time (e.g., transmission completion point) of the AC_VI frame on the second link may be a blindness period. The STA1 may not be able to perform a reception operation in the blindness period of the first link. Accordingly, the STA1 may perform a low-power operation in the blindness period of the first link. For example, the STA1 may operate in a micro sleep state in the blindness period of the first link.

In the exemplary embodiment of FIG. 3, the STA1 and STA2 may perform simultaneous transmission operations, and since the AC_VO TXOP limit of the first link is shorter than the AC_VI TXOP limit of the second link, the STA1 may not be able to add padding to the AC_VO frame in order to match the end times of the AC_VO frame and the AC_VI frame. Therefore, the STA1 of STA MLD1 may set an ACK policy field included in a MAC header of the AC_VO frame to a value indicating NSTR ML ACK, and transmit the AC_VO frame. The ACK policy field set to the value indicating NSTR ML ACK may indicate that the reception response frame for the AC_VO frame on the first link is transmitted after completion of reception of the AC_VI frame on the second link. In the instant case, the STA1 may not wait to receive the reception response frame for the AC_VO frame after transmission of the AC_VO frame. Determination of whether or not the AC_VO frame has been successfully received may be postponed until after the reception response frame is received.

Instead of setting the ACK policy field included in the MAC header to the value indicating NSTR ML ACK, the STA1 of STA MLD1 may transmit the AC_VO frame by including an AC_VO data unit and a block ACK request (BAR) in the AC_VO frame. Alternatively, the STA1 of STA MLD may transmit the AC_VO frame by including the NSTR ML ACK indication in the ACK policy field included in the MAC header, AC_VO data unit, and BAR. That is, the AC_VO frame may have an aggregated-MAC protocol data unit (A-MPDU) format, and the BAR included in the AC_VO frame may indicate NSTR ML ACK. The AP1 of AP MLD1 may receive the AC_VO frame on the first link and identify the value of the ACK policy field included in the AC_VO frame or whether the AC_VO frame includes the BAR. When the ACK policy field included in the AC_VO frame indicates NSTR ML ACK, and/or when the AC_VO frame includes the BAR (e.g., BAR indicating NSTR ML ACK), the AP1 may perform a backoff operation to transmit the reception response frame for the AC_VO frame. The backoff operation for transmission of the reception response frame may be performed using AC_VO EDCA parameter(s) (e.g., parameter(s) for selecting an AC_VO backoff counter value).

When the backoff operation for transmission of the reception response frame for the AC_VO frame is completed on the first link, the AP1 may identify whether the transmission operation (e.g., transmission operation of the AC_VI frame) is completed on the second link having an NSTR link pair relationship with the first link. If the transmission operation on the second link is not completed, the AP1 may re-perform a backoff operation for transmission of the reception response frame. If the backoff operation is completed on the first link and the transmission operation is completed on the second link having an NSTR link pair relationship with the first link, the AP1 of AP MLD1 may transmit the reception response frame for the AC_VO frame on the first link. The STA1 of STA MLD1 may receive the reception response frame for the AC_VO frame from the AP1.

As another method, if the backoff operation for transmission of the reception response frame for the AC_VO frame on the first link succeeds once, the AP1 of AP MLD1 may transmit the reception response frame after waiting until a time when the reception response frame can be transmitted. That is, the backoff counter value for the reception response frame may be maintained at 0 until a reception completion time of the AC_VI frame on the second link. As yet another method, the AP1 of AP MLD1 may perform a backoff operation for transmission of the reception response frame from a time when the reception response frame for the AC_VO frame can be transmitted (e.g., a reception completion time of the AC_VI frame on the second link), and transmit the reception response frame when the backoff operation succeeds.

‘The STA1 of STA MLD1 does not immediately receive the reception response frame for the AC_VO frame’ may be indicated by the ACK policy field included in the AC_VO frame transmitted on the first link, the BAR included in the AC_VO frame transmitted on the first link, and/or the BAR included in the AC_VI frame transmitted by the STA2 of STA MLD1 in form of an A-MPDU on the second link having the NSTR link pair relationship with the first link. The BAR may indicate a time when the STA1 of STA MLD1 receives the reception response frame. When the AC_VI frame received from the STA2 of STA MLD1 includes the BAR, the AP MLD1 may identify the time when the reception response frame can be received at the STA1 based on the BAR, and transmit the reception response frame for the AC_VO frame on the first link at the identified time. That is, the AP1 of AP MLD1 may transmit the reception response frame on the first link based on Method 1-1 described above.

The STA MLD1 may determine a success or failure of transmission of the data frame on the first link based on the reception response frame received on the first link after completion of transmission of the data frame on the second link. After determining a success or failure of transmission of the data frame, the STA MLD1 may update EDCA parameter(s) based on a result of the determination. When transmission of the data frame has failed, the STA MLD1 may double the EDCA parameter(s) for the first link. The STA MLD1 may retransmit the failed data frame. When transmission of the data frame has succeeded, the STA MLD1 may initialize the EDCA parameter(s) for the first link to initial value(s).

### Method 1-2 of Transmitting and Receiving a Reception Response Frame

The TXOP limit for the second link (e.g., AC_VI TXOP limit) may be longer than the TXOP limit for the first link (e.g., AC_VO TXOP limit). The AP2 of AP MLD1, which operates on the second link for which a long TXOP limit is configured, may transmit a reception response for the data frame (e.g., AC_VI frame) received on the second link together with a reception response for the data frame (e.g., AC_VO frame) received on the first link.

In the exemplary embodiment of FIG. 3, the STA1 and STA2 may perform simultaneous transmission operations, and since the AC_VO TXOP limit for the first link is shorter than the AC_VI TXOP limit for the second link, the STA1 may not be able to add padding to the AC_VO frame in order to match end times of the AC_VO frame and the AC_VI frame. Therefore, the STA1 of STA MLD1 may set an ACK policy field included in a MAC header of the AC_VO frame to a value indicating NSTR ML ACK, and transmit the AC_VO frame. In the instant case, the STA1 may not wait to receive a reception response frame for the AC_VO frame after transmission of the AC_VO frame. Determination of whether or not the AC_VO frame has been successfully received may be postponed until after the reception response frame is received.

The AP MLD1 (e.g., AP1) may receive the AC_VO frame on the first link and identify the ACK policy field included in the MAC header of the AC_VO frame. When the ACK policy field indicates NSTR ML ACK, the AP MLD1 may perform a procedure for transmitting the reception response frame for the AC_VO frame received on the first link on the second link. That is, the ACK policy field included in the AC_VO frame may indicate that the reception response frame for the AC_VO frame received on the first link is transmitted through another link (e.g., the second link). As another method, the above-described exemplary embodiment of the present invention may be performed based on a BAR included in the AC_VO frame of the first link instead of the ACK policy field. As another method, the above-described exemplary embodiment of the present invention may be performed based on a BAR included in the AC_VI frame of the second link instead of the ACK policy field. Alternatively, the exemplary embodiment of the present invention may be performed in a combination of the above-described methods. When reception of the data frame (e.g., AC_VI frame) is completed on the second link having an NSTR link pair relationship with the first link, the AP2 of AP MLD1 may transmit a reception response for the AC_VI frame received on the second link and a reception response for the AC_VO frame received on the first link through the second link. The STA MLD1 (e.g., STA2) may receive the reception response for the AC_VI frame and the reception response for the AC_VO frame through the second link.

The reception response for the AC_VI frame received on the second link and the reception response for the AC_VO frame received on the first link may be included in one reception response frame. In the instant case, the reception response frame may have an A-MPDU form. As another method, the reception response for the AC_VI frame received on the second link and the reception response for the AC_VO frame received on the first link may be included in different frames. That is, a reception response frame for the AC_VI frame received on the second link and a reception response frame for the AC_VO frame received on the first link may be transmitted through the second link.

‘The STA1 of STA MLD1 does not immediately receive the reception response frame for the AC_VO frame’ may be indicated by the ACK policy field included in the AC_VO frame transmitted by the STA1 of STA MLD1 on the first link, BAR included in the AC_VO frame transmitted by the STA1 of STA MLD1 in an A-MPDU form on the first link, and/or BAR included in the AC_VI frame transmitted by the STA2 of STA MLD1 in an A-MPDU form on the second link having an NSTR link pair relationship with the first link. The BAR included in the AC_VI frame may request transmission of the reception response for the data frame (e.g., AC_VO frame) received on the first link. That is, the BAR included in the AC_VI frame transmitted on the second link may request transmission of the reception response for the first link.

The AP2 of AP MLD1 may receive the AC_VI data frame from the STA2 of STA MLD1. When the AC_VI data frame includes the BAR, the AP2 of AP MLD1 may transmit the reception response frame for the data frame (e.g., AC_VO frame) received on the first link through the second link. The STA MLD1 may determine a success or failure of transmission of the data frame on the first link based on the reception response frame received on the second link after completion of transmission of the data frame on the second link. After determining a success or failure of transmission of the data frame, the STA MLD1 may update EDCA parameter(s) based on a result of the determination. When transmission of the data frame has failed, the STA MLD1 may double the EDCA parameter(s) for the first link. The STA MLD1 may retransmit the failed data frame. When transmission of the data frame has succeeded, the STA MLD1 may initialize the EDCA parameter(s) for the first link.

### Method 1-3 of Transmitting and Receiving a Reception Response Frame

The reception response frame for the data frame (e.g., AC_VO frame) transmitted on the first link may be transmitted on a third link not having an NSTR link pair relationship with the first link. In the exemplary embodiment of FIG. 3, the STA1 and STA2 may perform simultaneous transmission operations, and since the AC_VO TXOP limit for the first link is shorter than the AC_VI TXOP limit for the second link, the STA1 may not be able to add padding to the AC_VO frame in order to match end times of the AC_VO frame and the AC_VI frame. Therefore, the STA1 of STA MLD1 may set an ACK policy field included in a MAC header of the AC_VO frame to a value indicating NSTR ML ACK, and transmit the AC_VO frame. In the instant case, the STA1 may not wait to receive a reception response frame for the AC_VO frame after transmission of the AC_VO frame. Determination of whether or not the AC_VO frame has been successfully received may be postponed until after the reception response frame is received.

The AP MLD1 (e.g., AP1) may receive the AC_VO frame on the first link and identify the ACK policy field included in the MAC header of the AC_VO frame. When the ACK policy field indicates NSTR ML ACK (e.g., when the ACK policy field requests to transmit the reception response frame for the first link on another link not having an NSTR link pair relationship with the first link), the AP MLD1 may perform a procedure for transmitting the reception response frame for the AC_VO frame received on the first link on another link (e.g., third link) not having an NSTR link pair relationship with the first link. The AP MLD1 may select a link (e.g., third link) to transmit the reception response frame from among links mapped to an AC of the data frame received on the first link. Since the AC of the data frame received on the first link is AC_VO, the AP MLD1 may select a link (e.g., third link) not having NSTR link pair relationships with the first and second links among the links mapped to AC_VO based on traffic identifier (TID)-to-link mapping. If the TID-to-link mapping is configured as a default (e.g., all ACs are mapped to all links), the AP MLD1 may select a link (e.g., third link) not having NSTR link pair relationships with the first and second links among links.

The STA MLD1 may wait for reception of the reception response frame for the data frame on link(s) mapped to the AC of the data frame including the ACK policy field indicating NSTR ML ACK. The AP3 of AP MLD1 may perform a backoff operation on the third link to transmit the reception response frame for the data frame received on the first link. The backoff operation on the third link may be performed using AC_VO parameters (e.g., EDCA parameters) for the first link. When the backoff operation succeeds on the third link, the AP3 of AP MLD1 may identify whether the reception response frame can be transmitted on the third link. That is, the AP3 of AP MLD1 may identify whether reception of the data frame is completed on the first link and whether determination of a reception status of the data frame is completed. If reception of the data frame is not completed on the first link, the AP3 of AP MLD1 may repeatedly perform a backoff operation on the third link until it transmits the reception response frame. Each time the backoff operation is performed, a new backoff counter value may be selected without changing the EDCA parameter(s).

When the reception response frame can be transmitted on the third link, and a short interframe space (SIFS) elapses from a completion of reception of the data frame on the first link, the AP3 of AP MLD1 may transmit the reception response frame at a time when the backoff operation succeeds on the third link. A start time of the backoff operation on the third link may be a transmission start time or a transmission completion time of the data frame on the first link. Alternatively, the start time of the backoff operation on the third link may be a time of receiving the BAR on the second link. The STA MLD1 may determine a success or failure of transmission of the data frame on the first link based on the reception response frame received on the third link. After determining a success or failure of transmission of the data frame, the STA MLD1 may update EDCA parameter(s) based on a result of the determination. When transmission of the data frame has failed, the STA MLD1 may double the EDCA parameter(s) for the first link. The STA MLD1 may retransmit the failed data frame. When transmission of the data frame has succeeded, the STA MLD1 may initialize the EDCA parameters(s) for the first link to initial value(s).

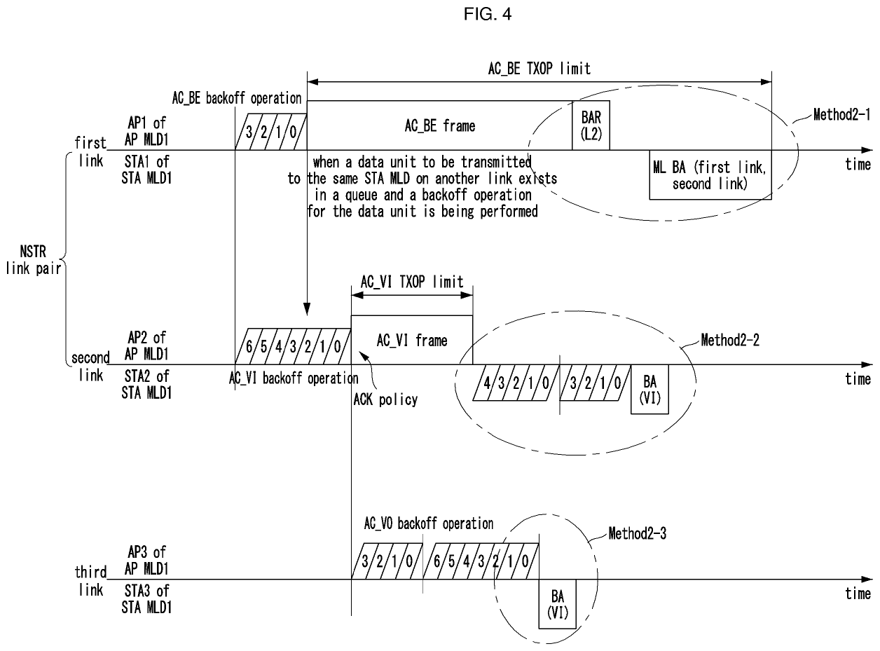

FIG. 4 is a timing diagram illustrating a second exemplary embodiment of a method for transmitting and receiving frames when different TXOP limits are applied in a wireless LAN system supporting multiple links.

As shown in FIG. 4, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. The STA MLD1 may operate as an NSTR STA MLD on a specific link pair (e.g., a pair of a first link and a second link), and may operate as an STR STA MLD on another link pair (e.g., a pair of the first link and a third link, and/or a pair of the second link and the third link). That is, the STA MLD1 cannot perform STR operations on the pair of the first link and the second link, and can perform STR operations on the pair of the first link and the third link and/or the pair of the second link and the third link.

The AP MLD1 may transmit and receive data frames with the STA MLD1 using a multi-link. The AP1 of AP MLD1 and the STA1 of STA MLD1 may operate on the first link, the AP2 of AP MLD1 and the STA2 of STA MLD1 may operate on the second link, and the AP3 of AP MLD1 and the STA3 of STA MLD1 may operate on the third link. Each of the AP1 and the STA1 may perform a backoff operation for transmission of a frame on the first link, each of AP2 and STA2 may perform a backoff operation for transmission of a frame on the second link, and each of the AP3 and the STA3 may perform a backoff operation for transmission of a frame on the third link.

The backoff operation may be performed independently on each link. The backoff operation may be an EDCAF. The backoff operations on the links may be backoff operations for the same AC. Alternatively, the backoff operations on the links may be backoff operations for different ACs. Multiple backoff operations (e.g., multiple backoff operations for multiple ACs) may be performed on one link. Value(s) of EDCA parameter(s) for the backoff operations may be different for each AC.

A backoff operation on one (e.g., first link) of the first link and the second link may succeed first when a backoff counter value thereof becomes 0. For example, a backoff operation may succeed first on a link (e.g., first link) for which a smaller backoff counter value is selected. When multiple backoff operations for multiple ACs are performed simultaneously, a backoff operation whose backoff counter value reaches 0 first may be determined to be successful. When the backoff operation succeeds, a data frame for an AC (e.g., AC_BE) that is a target of the backoff operation may be transmitted at a boundary of a slot where the backoff counter value becomes 0.

When an AC_BE backoff operation succeeds on the first link, the AP1 of AP MLD1 may transmit a data frame (e.g., AC_BE frame) on the first link. A TXOP obtained by the AP1 on the first link may be configured with a TXOP limit for the AC_BE frame. While the data frame is being transmitted on the first link, an AC_VI backoff operation may succeed on the second link. In the instant case, the AP2 of AP MLD1 may transmit a data frame for an AC (e.g., AC_VI) that is a target of the backoff operation at a boundary of a slot where the backoff counter value becomes 0. The data frames on the first link and the second link may be transmitted to the same STA MLD (e.g., STA MLD1). The STA MLD1 receiving the data frames may be an NSTR STA MLD on a specific link pair (e.g., a pair of the first and second links).

The AC_VI TXOP limit for the AC_VI frame on the second link may be shorter than the AC_BE TXOP limit for the AC_BE frame on the first link. Accordingly, the AP MLD1 may not be able to set an end time of the AC_VI frame transmitted on the second link to be the same as an end time of the AC_BE frame transmitted on the first link. That is, when padding is added to the AC_VI frame on the second link, the AC_VI frame including the padding may exceeds the AC_VI TXOP limit, so a padding procedure for matching a transmission end time of the AC_VI frame to a transmission end time of the AC_BE frame on the second link cannot be performed.

The AP MLD1 may identify condition(s) below to set an ACK policy field (e.g., ACK policy indicator) in a MAC header of the data frame to be transmitted on the second link.
Condition 1: A case where a data frame is being transmitted on a link (e.g., first link) different from the second link, and a recipient of the data frame being transmitted on the first link and a recipient of the data frame to be transmitted on the second link are the same NSTR STA MLD.
Condition 2: A case where transmission of the data frame on the second link ends while transmitting a data frame on the first link
Condition 3: A case where a TXOP limit of an AC of a data frame to be transmitted on the second link is shorter than a remaining duration of a TXOP configured on the first link

When the above-mentioned condition(s) are satisfied, the STA2 of STA MLD1 may not be able to transmit a frame (e.g., a reception response frame for the AC_VI frame) to the AP during a period corresponding to the AC_BE TXOP lint of the first link having an NSTR link pair relationship with the first link. Therefore, in order to prevent the STA2 of STA MLD1 from immediately transmitting the reception response frame for the data frame, the AP2 of AP MLD1 may set an ACK policy field included in a MAC header of the data frame (e.g., AC_VI frame) to ML ACK (e.g., NSTR ML ACK), and transmit the data frame on the second link. The ACK policy field indicating ML ACK may indicate to transmit the reception response frame for the data frame using another method.

### Method 2-1 of Transmitting and Receiving a Reception Response Frame

The AP2 of AP MLD1 may set the ACK policy field included in the MAC header of the data frame (e.g., AC_VI frame) to a value indicating ML ACK (e.g., NSTR ML ACK) and transmit the data frame on the second link. In the instant case, the AP MLD1 may postpone determination of a success or failure of transmission of the data frame, and may identify the reception response frame for the data frame (e.g., AC_BE frame) transmitted on the first link.

The STA MLD1 may receive the data frame (e.g., AC_VI frame) on the second link, and identify that the ACK policy field included in the MAC header of the data frame indicates ML ACK. In the instant case, the STA MLD1 may determine to transmit the reception response frame for the data frame received on the second link through the first link based on the information indicated by the ACK policy field. As another method, the above-described exemplary embodiment of the present invention may be performed based on a BAR included in the AC_VI frame of the second link instead of the ACK policy field. As another method, the above-described exemplary embodiment of the present invention may be performed based on a BAR included in the AC_BE frame of the first link instead of the ACK policy field. Alternatively, the exemplary embodiment of the present invention may be performed in a combination of the above-described methods. The STA MLD1 may transmit a reception response for the data frame received on the first link and a reception response for the data frame received on the second link through the first link. The reception response frame for the data frame received on the first link may include reception response information for the data frame received on the second link.

The AP1 of AP MLD1 may transmit the data frame on the first link, and may receive the reception response frame from the STA1 of STA MLD1 on the first link. The reception response frame received on the first link may include the reception response for the data frame transmitted on the first link and the reception response for the data frame transmitted on the second link. The AP MLD1 may determine a success or failure of transmission of the data frame on the second link based on the reception response frame received on the first link. After determining a success or failure of the transmission of the data frame, the AP MLD1 may update EDCA parameter(s) for the second link based on a result of the determination. When transmission of the data frame has failed, the AP MLD1 may double the EDCA parameter(s) for the second link. The AP MLD1 may retransmit the failed data frame. When transmission of the data frame has succeeded, the AP MLD1 may initialize the EDCA parameters(s) for the second link to initial value(s).

The data frame transmitted on the first link may include a BAR. The BAR may include an indicator requesting to transmit the reception response frame for the data frame transmitted on the second link through the first link. The STA1 of STA MLD1 may receive the data frame on the first link and identify the BAR included in the data frame. The STA1 of STA MLD1 may identify that the reception response frame for the data frame transmitted on the second link is requested to be transmitted through the first link based on the BAR. Accordingly, the STA1 of STA MLD1 may transmit a reception response for the data frame received on the first link and a reception response for the data frame received by the STA2 of STA MLD1 on the second link through the first link. Method 2-1 in the exemplary embodiment of FIG. 4 may be a method corresponding to Method 1-2 in the exemplary embodiment of FIG. 3 described above.

### Method 2-2 of Transmitting and Receiving a Reception Response Frame

After receiving the data frame on the second link, the STA2 of STA MLD1 may repeatedly perform a backoff operation for transmission of a reception response frame until a time at which it can transmit the reception response frame for the data frame. When the backoff operation for transmission of the reception response frame succeeds after the time at which the reception response frame can be transmitted (e.g., a time when reception of the AC_BE frame is completed on the first link), the STA2 of STA MLD1 may transmit the reception response frame on the second link. Method 2-2 in the exemplary embodiment of FIG. 4 may be a method corresponding to Method 1-1 in the exemplary embodiment of FIG. 3 described above.

### Method 2-3 of Transmitting and Receiving a Reception Response Frame

The AP2 of AP MLD1 may set an ACK policy field included in a MAC header of the data frame (e.g., AC_VI frame) to a value indicating ML ACK (e.g., NSTR ML ACK), and transmit the data frame on the second link. The STA2 of STA MLD1 may receive the data frame on the second link and identify that the ACK policy field included in the MAC header of the data frame indicates ML ACK. In the instant case, the STA MLD1 may perform a backoff operation for transmission of the reception response frame for the data frame received on the second link through another link (e.g., third link) not having NSTR link pair relationships with the first link and the second link. The STA MLD1 may select a link (e.g., third link) to transmit the reception response frame from among links mapped to an AC of the data frame received on the second link. Since the AC of the data frame received on the second link is AC_VI, the STA MLD1 may select a link (e.g., third link) not having NSTR link pair relationships with the first link and the second link among the links mapped to AC_VI based on traffic identifier (TID)-to-link mapping. The STA3 of STA MLD1 may transmit the reception response frame for the data frame received on the first link through the third link. A backoff operation may be performed for transmission of the reception response frame on the third link.

The backoff operation performed by the STA3 of STA MLD1 on the third link may be repeatedly performed until the reception response frame for the data frame received on the second link is transmitted. When reception of the data frame is completed on the second link and identification of a reception status of the data frame is completed, the reception response frame may be generated. The backoff operation may be repeatedly performed at least from a reception start time of the data frame to a time when an SIFS elapses from an end time of the data frame. The backoff operation on the third link may be performed using AC_VI parameters (e.g., EDCA parameter(s)) for the second link. Alternatively, the backoff operation on the third link may use AC_VO parameter(s) for fast transmission of the reception response frame. Each time the backoff operation is performed, the EDCA parameter(s) may not be changed, and a new backoff counter value may be selected. When the backoff operation succeeds on the third link, the STA3 of STA MLD1 may identify whether it is in a state capable of transmitting the reception response frame on the third link. That is, the STA3 of STA MLD1 may identify whether reception of the data frame on the second link is completed and whether determination of a reception status of the data frame is completed. When the reception response frame can be transmitted on the third link, and a SIFS elapses from a reception completion time of the data frame on the second link, the STA3 of STA MLD1 may transmit the reception response frame at a time when the backoff operation succeeds on the third link. Method 2-3 in the exemplary embodiment of FIG. 4 may be a method corresponding to Method 1-3 in the exemplary embodiment of FIG. 3 described above.

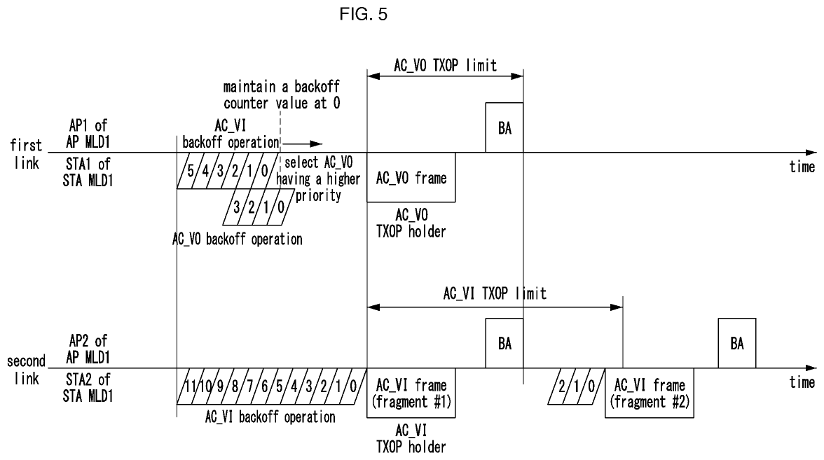

FIG. 5 is a timing diagram illustrating a third exemplary embodiment of a method for transmitting and receiving frames when different TXOP limits are applied in a wireless LAN system supporting multiple links.

As shown in FIG. 5, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. The STA MLD1 may transmit data frames simultaneously on the first link and the second link. An AC of the data frame transmitted on the first link may be different from an AC of the data frame transmitted on the second link. For example, an AC_VO frame on the first link and an AC_VI frame on the second link may be transmitted simultaneously. The AC_VO TXOP limit may be shorter than the AC_VI TXOP limit. When the NSTR MLD performs simultaneous transmission using a multi-link, the data frames may be configured to fit a shorter TXOP limit (e.g., AC_VO TXOP).

A fragmentation operation for a data unit (e.g., AC_VI frame) transmitted according to the AC_VI TXOP limit for the second link may be performed in accordance with the AC_VO TXOP limit on the first link. When the data frame transmitted on the second link is generated in form of an A-MPDU, the A-MPDU may be configured according to the duration of the AC_VO TXOP on the first link. In a procedure of configuring the A-MPDU, padding may be added to the data frame (e.g., A-MPDU) of the second link to satisfy the AC_VO TXOP limit on the first link.

The STA MLD1 may configure the AC_VO frame to transmit the AC_VO frame and receive a reception response frame (e.g., BA frame) for the AC_VO frame within the AC_VO TXOP limit on the first link, and transmit the AC_VO frame. The STA MLD1 may configure the AC_VI frame to transmit the AC_VI frame on the second link at the same time as the AC_VO frame on the first link and receive a reception response frame (e.g., BA frame) for the AC_VI frame, and transmit the AC_VI frame. After the synchronous transmissions of data frames on the first link and the second link, the STA MLD1 may transmit the remaining AC_VI frame after performing a backoff operation again on the second link. Alternatively, when the remaining part of the AC_VI frame on the second link is within a length transmittable within the remaining TXOP, the STA2 of STA MLD1 may not perform a backoff operation again, and may transmit the remaining frame after a SIFS elapses from a time of receiving the BA frame.

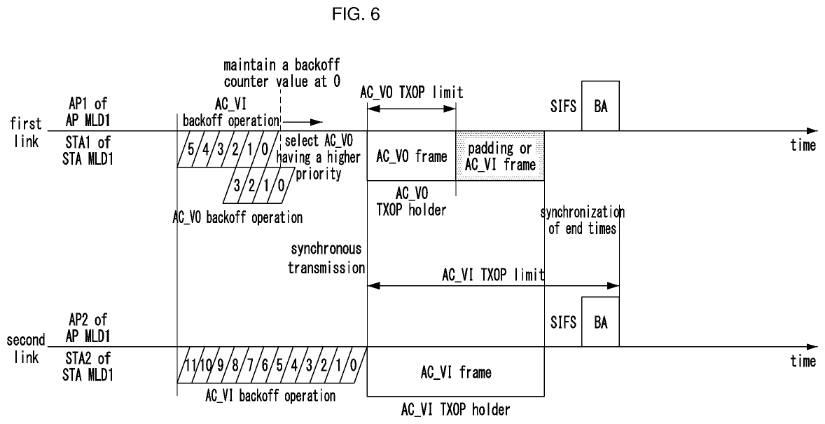

FIG. 6 is a timing diagram illustrating a fourth exemplary embodiment of a method for transmitting and receiving frames when different TXOP limits are applied in a wireless LAN system supporting multiple links.

As shown in FIG. 6, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. The STA MLD1 may transmit data frames simultaneously on the first link and the second link. An AC of the data frame transmitted on the first link may be different from an AC of the data frame transmitted on the second link. For example, an AC_VO frame on the first link and an AC_VI frame on the second link may be transmitted simultaneously. The AC_VO TXOP limit may be shorter than the AC_VI TXOP limit. When the NSTR MLD performs simultaneous transmission using a multi-link, the data frames may be configured to fit a shorter TXOP limit.

The AC_VO TXOP limit on the first link may be extended depending on the length of the data frame transmitted on the second link. That is, it may be allowed for transmission of the data frame to end after the TXOP limit. The STA MLD1 (e.g., STA1) may transmit the data frame (e.g., AC_VO frame) within the extended TXOP limit, and perform a transmission operation of a data unit existing in a queue or a transmission operation of padding in the remaining time within the extended TXOP limit. The STA1 of STA MLD1 may select a data unit (e.g., AC_VI data unit) among data units existing in the queue, which was not selected by an internal collision resolution procedure although a backoff operation therefor was successful, to transmit the data unit. Alternatively, the STA1 of STA MLD1 may transmit a data frame or data unit of an AC with the same priority or higher priority as the AC of the data frame transmitted within the extended TXOP limit.

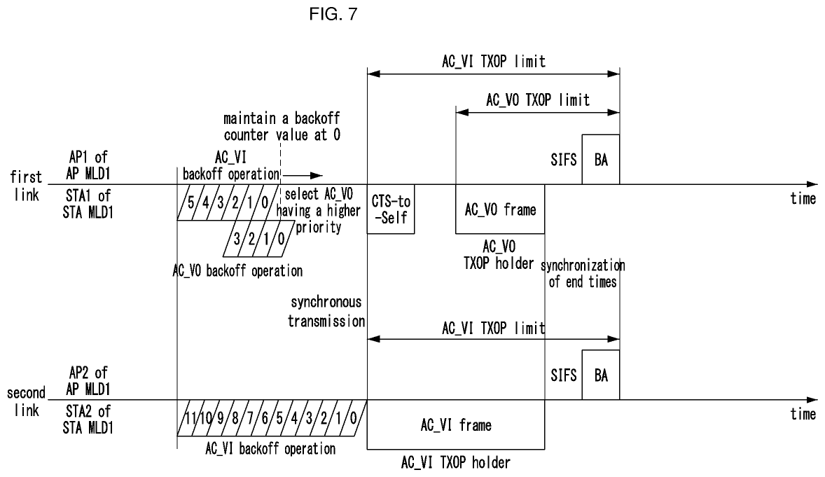

FIG. 7 is a timing diagram illustrating a fifth exemplary embodiment of a method for transmitting and receiving frames when different TXOP limits are applied in a wireless LAN system supporting multiple links.

As shown in FIG. 7, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. The STA MLD1 may transmit data frames simultaneously on the first link and the second link. An AC of the data frame transmitted on the first link may be different from an AC of the data frame transmitted on the second link. The AC_VO TXOP limit may be shorter than the AC_VI TXOP limit. When the NSTR MLD performs simultaneous transmission using a multi-link, transmission of the data frame according to the short TXOP limit may be delayed so that end times of the data frames transmitted on the links are the same.

In order to match an end time of the AC_VO frame on the first link and an end time of the AC_VI frame on the second link, transmission of the AC_VO frame on the first link may be delayed. If a time from a transmission start time of the AC_VI frame on the second link to a transmission start time of the delayed AC_VO frame on the first link is longer than a time required for transmission of a QoS Null frame or clear-to-send (CTS)-to-Self frame, the STA MLD1 may transmit a QoS Null frame or CTS-to-Self frame on the first link including a duration field set to the same as a value of a duration field of the AC_VI frame transmitted on the second link. The QoS Null frame (or CTS-to-Self frame) on the first link and the AC_VI frame on the second link may be transmitted simultaneously. The QoS Null frame (or CTS-to-Self frame) on the first link may be transmitted based on parameter(s) (e.g., TXOP limit) for the AC_VI frame on the second link.

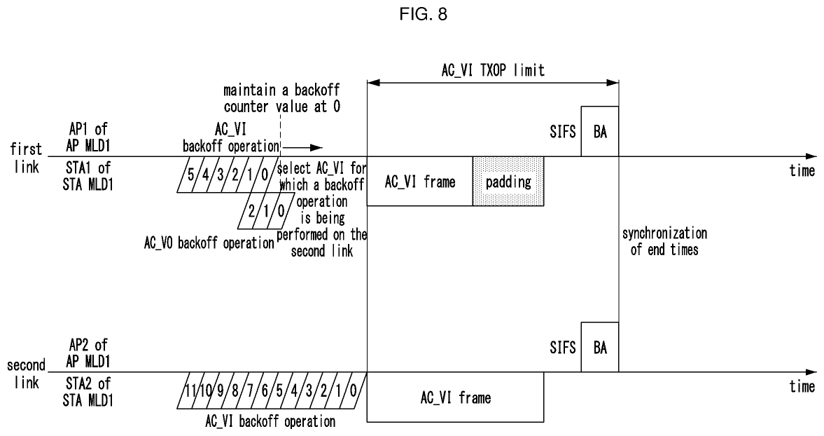

FIG. 8 is a timing diagram illustrating a sixth exemplary embodiment of a method for transmitting and receiving frames when different TXOP limits are applied in a wireless LAN system supporting multiple links.

As shown in FIG. 8, the AP MLD1 may transmit and receive data frames with the STA MLD1 using a multi-link. The AP1 of AP MLD1 and the STA1 of STA MLD1 may operate on the first link, and the AP2 of AP MLD1 and the STA2 of STA MLD1 may operate on the second link. Each of the AP1 and the STA1 may perform a backoff operation for transmission of a frame on the first link, and each of AP2 and STA2 may perform a backoff operation for transmission of a frame on the second link.

The backoff operation may be performed independently on each link. The backoff operation may be an EDCAF. The backoff operations on the links may be backoff operations for the same AC. Alternatively, the backoff operations on the links may be backoff operations for different ACs. Multiple backoff operations (e.g., multiple backoff operations for multiple ACs) may be performed on one link. Value(s) of EDCA parameter(s) for the backoff operations may be different for each AC.

The backoff operations for synchronous transmissions may be performed for the same AC on both the first and second links, and may use the same EDCA parameter(s). Counter values for the backoff operations on the first link and the second link may be selected independently. The counter value may mean a backoff counter value. The backoff operation on one (e.g., first link) of the first link and the second link may succeed first when the backoff counter value thereof becomes 0. For example, the backoff operation may succeed first on a link (e.g., first link) for which a smaller backoff counter value is selected. The backoff counter value on the first link where the backoff operation succeeds may be maintained at 0 until the AC_VI backoff operation succeeds on another link (e.g., second link). In the instant case, transmission on the first link may be delayed (i.e., queued).

The STA1 of STA MLD1 may simultaneously perform the backoff operation for AC_VI (hereinafter referred to as ‘AC_VI backoff operation’) and the backoff operation for AC_VO (hereinafter referred to as ‘AC_VO backoff operation’) on the first link. The AC_VI backoff operation may succeed before the AC_VO backoff operation, and the AC_VI backoff counter value on the first link may be maintained at 0 until the backoff counter value on the second link becomes 0. The AC_VO backoff operation may be completed while waiting for transmission of AC_VI data on the first link. In the instant case, both the AC_VI backoff counter value and the AC_VO backoff counter value on the first link may be 0.

When the backoff operations for two or more ACs on one link succeed, an internal collision resolution procedure may be performed to select one AC which is a transmission target. In the internal collision resolution procedure, a backoff operation for the same AC as the AC of the backoff operation on another link may be selected. Since the AC_VI backoff operation is in progress on the second link, the AC_VI backoff operation on the first link may be selected. That is, it may be determined that the AC_VI backoff operation on the first link is successful. Alternatively, if the AC_VO backoff is in progress on the second link, the AC_VO backoff operation, which has a higher priority than AC_VI, may be selected on the first link according to the priorities in Table 1.

When the AC_VI backoff operation on the second link succeeds (e.g., when the AC_VI backoff counter value becomes 0), the STA1 of STA MLD1 may transmit the AC_VI frame on the first link, and the STA2 of STA MLD1 may transmit the AC_VI frames on the second link. A TXOP on each link may be configured according to the AC_VI TXOP limit. The AC_VI frame on the first link and the AC_VI frame on the second link may be transmitted simultaneously. The TXOP limits for AC on the first link and the second link may be the same. Therefore, transmission end times thereof may be synchronized through padding, etc. The above-described exemplary embodiment of the present invention may also be applied when the AP MLD performs downlink transmission to the STA MLD.

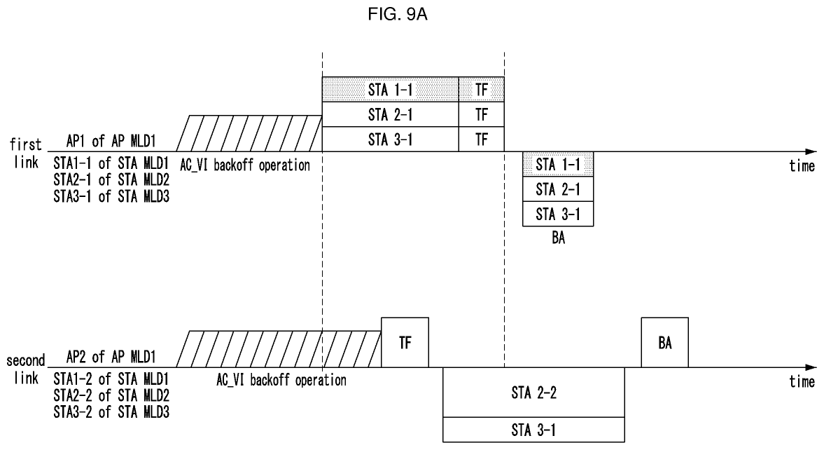

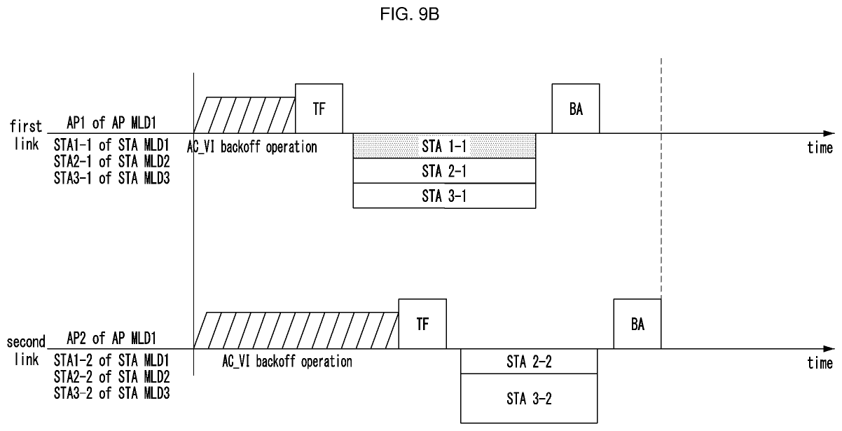

FIG. 9A is a timing diagram illustrating a first exemplary embodiment of a multi-user (MU) transmission method in a wireless LAN system supporting a multi-link, and FIG. 9B is a timing diagram illustrating a second exemplary embodiment of an MU transmission method in a wireless LAN system supporting a multi-link.

As shown in FIGS. 9A and 9B, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. The STA MLD1 may participate in Orthogonal Frequency Division Multiple Access (OFDMA) MU transmission on multiple links (multi-link). A STA1-1 of STA MLD1 may participate in downlink OFDMA MU transmission on the first link, receive a data frame through a subchannel on the first link, and transmit a reception response frame for the data frame through a subchannel. While the AP1 of AP MLD1 is performing downlink OFDMA MU transmission on the first link, the AP2 of AP MLD1 may transmit a trigger frame (TF) for uplink OFDMA MU transmission on the second link. The STA MLD1 may receive the TF from the AP MLD1, and STA(s) associated with STA MLD1 may transmit data frame(s) (e.g., trigger based (TB) PPDU) to the AP2 through a subchannel after a SIFS elapses from a reception time of the TF. Even when receiving the TF triggering uplink transmission, the STA MLD1, which is an NSTR STA MLD, may not be able to perform uplink transmission if a downlink OFDMA MU reception operation is being performed. Therefore, the AP MLD1 may not transmit the TF including allocation information of uplink resources for the STA1-1 of STA MLD1 performing a reception operation on the first link and the STA 1-2 of the second link having an NSTR link pair relationship with the first link. That is, the TF through which the AP MLD1 triggers uplink OFDMA MU transmission on the second link may not include allocation information of uplink resources for the STA1-2.

In the exemplary embodiment of FIG. 9B, the STA1-1 of STA MLD1, which is an NSTR STA MLD, may transmit a data frame (e.g., TB PPDU) through a subchannel indicated by the TF triggering uplink OFDMA MU transmission on the first link. and may receive a reception response frame for the data frame. While the STA1-1 of STA MLD1 is performing uplink OFDMA MU transmission on the first link, the STA1-2 of STA MLD1 may not receive a TF triggering uplink OFDMA MU transmission from the AP2 of AP MLD1 on the second link. Therefore, the AP MLD1 (e.g., AP2) may not transmit a TF including allocation information of uplink resources for the STA MLD1 performing a reception operation on the first link. That is, the TF through which the AP MLD 1 triggers uplink OFDMA MU transmission on the second link may not include allocation information of uplink resources for the STA1-2.

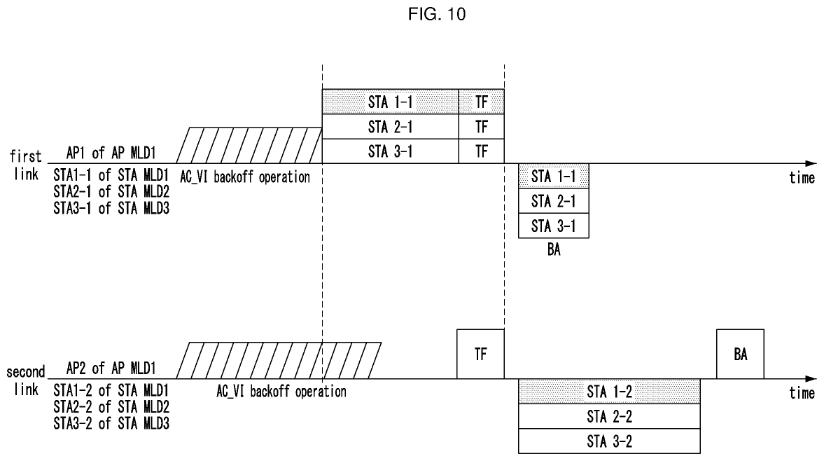

FIG. 10 is a timing diagram illustrating a third exemplary embodiment of an MU transmission method in a wireless LAN system supporting a multi-link.

As shown in FIG. 10, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. A STA1-1 of STA MLD1 may participate in downlink OFDMA MU transmission on the first link, receive a data frame through a subchannel on the first link, and transmit a reception response frame for the data frame through a subchannel. While the AP1 of AP MLD1 is performing downlink OFDMA MU transmission on the first link, the AP2 of AP MLD1 may transmit a TF for uplink OFDMA MU transmission on the second link.

The STA MLD1 may receive the TF including allocation information of uplink resources on the second link while performing downlink OFDMA MU reception on the first link. In the instant case, the STA MLD1 may not be able to perform a channel sensing operation during a preset time (e.g., SIFS) on the second link, and perform a transmission operation using uplink resources indicated by the TF without performing a channel sensing operation. Alternatively, the STA 1-2 of STA MLD1 may perform a channel sensing operation during a preset time on the second link, and then perform an uplink transmission operation on the second link. However, the above-described uplink transmission operation of the STA MLD1 on the second link may cause interference to the first link. Therefore, the STA MLD1 may not be able to perform the above-described uplink transmission operation on the second link. The AP2 of AP MLD1 may transmit the TF after waiting for a certain time period (e.g., time required for matching a downlink transmission end time of the first link and an end time of the TF on the second link) after completion of the backoff operation on the second link in order to make the transmission end time of the TF on the second link and the downlink transmission end time on the first link the same. Through the operation of the AP2 of AP MLD1 delaying the transmission of TF on the second link, the uplink transmission of the STA1-2 on the second link may not affect the downlink data reception of STA1-1 on the first link.

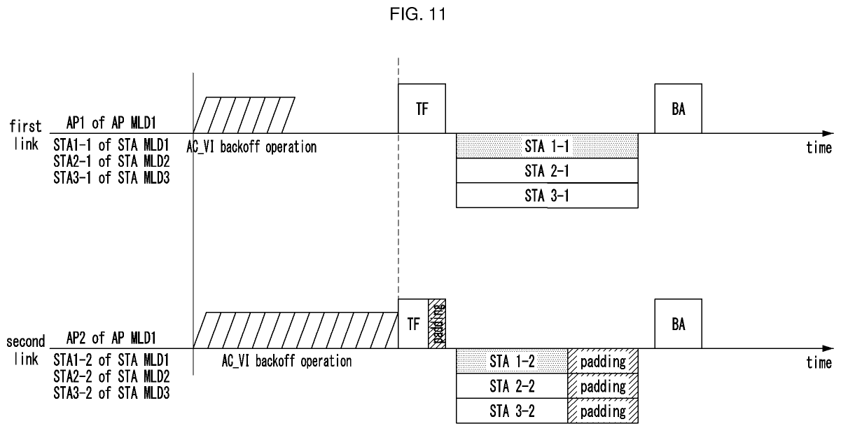

FIG. 11 is a timing diagram illustrating a fourth exemplary embodiment of an MU transmission method in a wireless LAN system supporting a multi-link.

As shown in FIG. 11, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. For the STA MLD1 to participate in uplink OFDMA MU transmission on the first link and the second link, transmission periods of the TF and uplink data frame should be synchronized. That is, synchronous transmissions of the TFs should be performed on the first link and the second link, and the transmission completion times of the TFs should be the same. Even when the backoff operation for TF transmission on the first link succeeds before the backoff operation for TF transmission on the second link, the AP MLD1 may wait for TF transmission on the first link until the backoff operation for TF transmission on the second link is completed. That is, the AP MLD1 may transmit the TFs simultaneously on the first link and the second link.

The length of the TF transmitted on the first link and the length of the TF transmitted on the second link may vary depending on the number of STAs whose transmission is triggered by the corresponding TF. A short-length TF may be configured to match a long-length TF. When the TFs use different modulation and coding schemes (MCSs), a TF with a short transmission time may be configured to match a TF with a long transmission time. The above-described operation may be performed regardless of the number of STAs for which transmission is triggered by the TF. According to the above-described operation, the transmission completion times of TFs on multiple links may be set to be the same. In order to match the transmission times of the TFs on multiple links, a padding operation for TF(s) may be performed.

The STA MLD1 may receive the TF from the AP MLD1 and perform uplink transmission using resources allocated by the TF. The STA MLD1, which is an NSTR STA MLD, may not receive a frame on one link while performing uplink transmission on another link. Therefore, the AP MLD1 may allocate uplink resources so that the uplink resources allocated by the TFs on multiple links end at the same time. The STAs of STA MLD1 may transmit frames according to the uplink resources allocated by the TF. In addition, the STA(s) of other STA MLD(s) triggered by the AP MLD 1 may transmit frames according to the uplink resources allocated by the TF. To support the above-described operation, the STA(s) of STA MLD1 may add padding to the data frame. In addition, STA(s) of other STA MLD(s) triggered by the AP MLD I may add padding to the data frame.

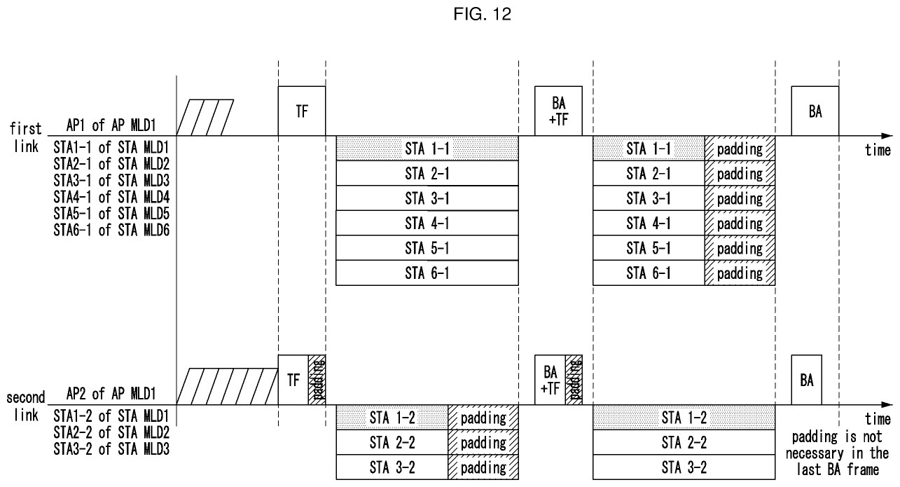

FIG. 12 is a timing diagram illustrating a fifth exemplary embodiment of an MU transmission method in a wireless LAN system supporting a multi-link.

As shown in FIG. 12, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. When uplink OFDMA MU transmission is performed multiple times, if the STA MLD1, which is an NSTR STA MLD, participates in uplink OFDMA MU transmission, a transmission period and a reception period may need to be synchronized. Since the STA MLD1 participates in uplink OFDMA MU transmission, synchronized transmission for the TF on the first link and the TF on the second link may be performed, and a transmission completion time of the TF on the first link and a transmission completion time of the TF on the second link may be synchronized. The lengths of uplink data frames transmitted through subchannels on the first link and the second link may be set to be the same, and the STA(s) of STA MLD(s) triggered by the TF of the AP MLD1 may add padding to uplink data. Accordingly, end times of the uplink transmissions on the first link and the second link may be synchronized.

A reception response frame (e.g., BA frame) transmitted by the AP MLD1 may include a TF for next uplink OFDMA MU transmission. The above-described BA frame including the TF may be referred to as ‘BA frame+TF’. For example, ‘BA frame+TF’ may be configured in form of an A-MPDU. Alternatively, ‘BA frame+TF’ may be configured as separate frames and transmitted subsequently. The length of the BA frame and the length of the TF may vary depending on the number of STAs participating in uplink OFDMA MU transmission and/or MCSs therefor. Therefore, when the STA MLD1, which is an NSTR STA MLD, participates in uplink OFDMA MU transmission on the first link and the second link, the AP MLD1 may perform synchronized transmission for ‘BA frame+TF’. A transmission start time and a transmission end time of ‘BA frame+TF’ on the first link may be the same as a transmission start time and a transmission end time of ‘BA frame+TF’ on the second link. In order to synchronize the transmission end times of ‘BA frame+TF’ on the first link and the second link, padding may be added to ‘BA frame+TF’ of the second link. The AP MLD1 may allocate uplink resources so that uplink transmission periods are synchronized on the first link and the second link. If transmission of the NSTR STA MLD is not performed after transmission of the BA frame (e.g., if the AP MLD 1 no longer allocates uplink resources), transmission end times of the BA frames on the first link and the second link may not be synchronized.

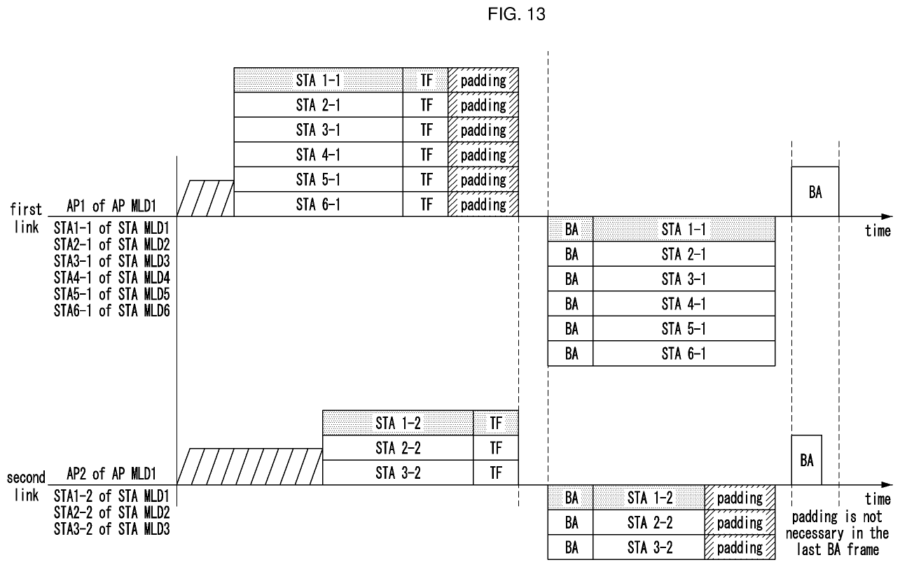

FIG. 13 is a timing diagram illustrating a sixth exemplary embodiment of an MU transmission method in a wireless LAN system supporting a multi-link.

As shown in FIG. 13, an AP MLD that supports STR operations may be referred to as an STR AP MLD, and a non-AP MLD that does not support STR operations may be referred to as an NSTR non-AP MLD (or NSTR STA MLD). The AP MLD1 may be an STR AP MLD, and the STA MLD1 may be an NSTR STA MLD. The AP MLD1 may perform downlink OFDMA MU transmission on the second link while performing downlink OFDMA MU transmission on the first link. The STA MLD1 (e.g., STA1-1 and STA1-2), which is an NSTR STA MLD, may participate in downlink OFDMA MU transmission on the first link and the second link. Transmission end times of downlink data transmitted on the first link and the second link may be different due to a difference between backoff end times of the first link and the second link or a difference between MCSs of the downlink data of the first link and the second link. Since the STA MLD1 cannot perform STR operations, downlink OFDMA MU transmissions on the first link and the second link need to end at the same time. To support this operation, padding may be added to the downlink frame(s). The length of the padding may be a length that makes the transmission end times of the downlink data transmitted on the second link and the first link the same.

If uplink OFDMA MU transmission is performed after downlink OFDMA MU transmission, a specific frame in the downlink OFDMA MU transmission procedure may include a TF for the uplink OFDMA MU transmission. If the NSTR STA MLD participates in downlink and/or uplink OFDMA MU transmission, synchronized transmissions may be required. In the instant case, an uplink OFDMA transmission period allocated by the TF on the multi-link may be the same time period on the first link and the second link. The STA(s) may perform uplink transmission (e.g., transmission of an uplink data frame) in a time period allocated by the TF and transmit padding in the remaining time period. If transmission of the NSTR STA MLD is not performed after transmission of the BA frame, the transmission end times of the BA frames on the first link and the second link may not be synchronized.

The exemplary embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who are skilled in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of a first device, the method comprising:
receiving a first frame from a second device in a first transmit opportunity (TXOP) of a first link;
receiving a second frame from the second device in a second TXOP of a second link;
performing a first backoff operation for transmission of a first reception response frame for the first frame on the first link; and
in response that the first backoff operation is completed and reception of the second frame is completed, transmitting the first reception response frame to the second device on the first link,
wherein the first TXOP is shorter than the second TXOP, and a reception completion time of the second frame is after a reception completion time of the first frame.

2. The method of claim 1, wherein an acknowledgement (ACK) policy field included in a medium access control (MAC) header of the first frame is set to a value indicating non-simultaneous transmit and receive (NSTR) multi-link (ML) ACK, and the ACK policy field set to the value indicating the NSTR ML ACK indicates to transmit the first reception response frame after completion of the reception of the second frame.

3. The method of claim 1, wherein the first frame includes a block ACK request (BAR) indicating NSTR ML ACK, and the BAR indicates to transmit the first reception response frame after completion of the reception of the second frame.

4. The method of claim 1, wherein the first backoff operation is performed using an enhanced distributed channel access (EDCA) parameter for an access category (AC) of the first frame.

5. The method of claim 1, wherein the first backoff operation is repeatedly performed until the reception of the second frame is completed; when the first backoff operation is completed before the reception of the second frame is completed, a backoff counter value for the first backoff operation is maintained at 0 until the reception of the second frame is completed; or the first backoff operation is performed after the reception of the second frame is completed.

6. The method of claim 1, wherein in response that the first device is an access point (AP) multi-link device (MLD), the second device is a station (STA) MLD, and in response that the first device is an STA MLD, the second device is an AP MLD; the AP MLD supports a simultaneous transmit and receive (STR) operation on the first link and the second link; and the STA MLD does not support the STR operation on the first link and the second link.

7. The method of claim 6, wherein a station (STA) 1 affiliated with the STA MLD performs a low-power operation on the first link in a period from an end time of the first frame to an end time of the second frame.

8. A method of a first device, the method comprising:
receiving a first frame from a second device in a first transmit opportunity (TXOP) of a first link;
receiving a second frame from the second device in a second TXOP of a second link; and
in response that information included in the first frame indicates that a first reception response for the first link is transmitted on the second link, transmitting the first reception response for the first frame and a second reception response for the second frame to the second device on the second link,
wherein the first TXOP is shorter than the second TXOP, and a reception completion time of the second frame is after a reception completion time of the first frame.

9. The method of claim 8, wherein the information is an acknowledgement (ACK) policy field included in a medium access control (MAC) header of the first frame, and the ACK policy field is set to a value indicating non-simultaneous transmit and receive (NSTR) multi-link (ML) ACK.

10. The method of claim 8, wherein the information is a block ACK request (BAR) included in the first frame.

11. The method of claim 8, wherein the transmitting to the second device includes:
generating one reception response frame including the first reception response and the second reception response; and
transmitting the one reception response frame to the second device.

12. The method of claim 8, wherein the transmitting to the second device includes:
transmitting a first reception response frame including the first reception response to the second device; and
transmitting a second reception response frame including the second reception response to the second device.

13. The method of claim 8, wherein in response that the first device is an access point (AP) multi-link device (MLD), the second device is a station (STA) MLD, and in response that the first device is an STA MLD, the second device is an AP MLD; the AP MLD supports a simultaneous transmit and receive (STR) operation on the first link and the second link; and the STA MLD does not support the STR operation on the first link and the second link.

14. A method of a first device, the method comprising:
receiving a first frame from a second device in a first transmit opportunity (TXOP) of a first link;
receiving a second frame from the second device in a second TXOP of a second link; and
in response that information included in the first frame requests to transmit a first reception response frame for the first frame on a third link that does not have a non-simultaneous transmit and receive (NSTR) link pair relationship with the first link, transmitting the first reception response frame to the second device on the third link.

15. The method of claim 14, wherein the first link and the second link are a non-simultaneous transmit and receive (NSTR) link pair, the first TXOP is shorter than the second TXOP, and a reception completion time of the second frame is after a reception completion time of the first frame.

16. The method of claim 14, wherein the transmitting to the second device comprises;
selecting the third link not having an NSTR link pair relationship with the first link from among links mapped to an access category (AC) of the first frame;
performing a first backoff operation for transmission of the first reception response frame on the third link; and
in response that the first backoff operation is completed, transmitting the first reception response frame to the second device on the third link.

17. The method of claim 16, wherein the third link is selected based on traffic identifier (TID)-to-link mapping.

18. The method of claim 16, wherein the first backoff operation on the third link is performed using an enhanced distributed channel access (EDCA) parameter for an AC of the first frame.

19. The method of claim 14, wherein the information is an acknowledgment (ACK) policy field included in a medium access control (MAC) header of the first frame, and the ACK policy field is set to a value indicating NSTR multi-link (ML) ACK.

20. The method of claim 14, wherein in response that the first device is an access point (AP) multi-link device (MLD), the second device is a station (STA) MLD, and in response that the first device is an STA MLD, the second device is an AP MLD; the AP MLD supports a simultaneous transmit and receive (STR) operation on the first link and the second link; and the STA MLD does not support the STR operation on the first link and the second link.
